(19) United States
(12) Patent Application Publication
(10) Pub. No.: US 2010/0160128 A1
(43) Pub. Date: Jun. 24, 2010

(54) ROLLER FOR A PRINTING MACHINE AND METHOD FOR MANUFACTURING THE ROLLER

(75) Inventors: Andreas Erber, Stuttgart (DE); Tjark von Reden, Stuttgart (DE); Stefan Carosella, Leutenbach (DE); Klaus Drechsler, Feldkirchen-Westerham (DE)

Correspondence Address: VENABLE LLP, P.O. BOX 34385, WASHINGTON, DC, 20043-9998, US

(73) Assignee: Mueller Martini Holding AG, Hergswil (CH)

(21) Appl. No.: 12/644,955

(22) Filed: Dec. 22, 2009

(30) Foreign Application Priority Data
Dec. 22, 2008 (EP) 08405312.3

(51) Int. Cl. A01B 29/00; B21K 1/02

(52) U.S. Cl. 492/30; 29/895.21

(57) ABSTRACT

There is provided a roller for a printing machine that includes a cylindrically shaped wall with at least partially one layer of a fiber braid and plastics material infiltrated in the fiber braid.

### CROSS-REFERENCE TO RELATED APPLICATION

This application claims priority to European Patent Application No: 08405312.3 filed on Dec. 22, 2008 which is incorporated herein by reference in its entirety.

### BACKGROUND

The subject matter of the application relates to a roller for a printing machine. A broad range of rollers, which inter alia convey a material to be imprinted, absorb printing ink and/or dispense printing ink to the material to be imprinted. The rollers are conventionally arranged in printing machines, in particular rotary printing machines. Rollers of this type are usually made of metal. Therefore, the rollers have a tendency, especially in the case of a high axial width, toward deflection. The rollers also have a tendency to form local temperature elevations and generally have a high weight. Rollers of this type are conventionally exposed to stresses as a result of bending and crushing.

In individual cases, other materials have also been used in the design of rollers. With the aid of alternative materials of this type, the weight of the rollers may be reduced and, depending on the material selected, their strength properties and thermal resistance to changes in dimension may also be improved.

German patent document DE 10 2007 006 207 A1 discloses a printing machine cylinder with a roller basic element made of fibre-reinforced plastics material. The plastics material is in particular epoxy resin or polyurethane. European patent document EP 1 754 601 A1 also discloses a roller in the form of a sleeve consisting of plastics material, for example a carbon fibre-reinforced plastics material.

### SUMMARY

Embodiments of the application may provide a roller with a further reduction in weight and may provide a roller with improved strength properties in comparison with rollers made of a plastics material. A further embodiment of the application may also provide a manufacturing method which may be carried out in a flexible and economical manner.

According to one embodiment, there is provided a roller for a printing machine, comprising: a cylindrically shaped wall comprising at least partially one layer of a fiber braid and plastics material infiltrated in the fiber braid.

According to a further aspect of the invention, there is provided a method of manufacturing a roller, comprising: providing a braided core; surrounding the braided core with at least one of braiding yarns or braiding yarns and warp inlay yarns to form a fiber braid; and infiltrating the fiber braid with plastics material.

A simple method for manufacturing a roller may be provided which meets the various requirements of rollers having different functions in printing machines.

Thus, the roller according to embodiments of the application, may be made at least partially of plastics material with fibres being arranged in the form of at least one layer of a fibre braid.

Another embodiment of the subject matter of the application may have a further saving of weight with improved strength properties of the roller with respect to the stresses caused by bending and crushing in comparison with conventional rollers. The arrangement of the fibres in the fibre braid of the fibre-reinforced plastics material may be responsible for the weight savings.

A unidirectional, biaxial or triaxial braid made of braiding yarns used in fibre braids of this type may be used. In embodiments of the triaxial braid, warp inlay yarns may be oriented in an axial direction of the roller and braided-in (weaved) between the biaxial braiding yarns. As a result, the fibres may be oriented in a targeted manner in relevant loading directions. This type of braiding-round may fix the warp inlay yarns in the axial direction of the roller and set them safely apart from one another.

Among the various possible fibre braid geometries, a triaxial fibre braid may be used because an axial warp inlay yarn, supported by biaxial braiding yarns that are braided round symmetrically to the longitudinal axis of the roller, may help to provide rigidity in preventing deflection. In accordance with some loads, braiding angles of from 45° to 90°, in particular 60° to 70°, between biaxial braiding yarns and warp inlay yarns may be provided. The braiding angle may be generally spanned between the braiding yarns and an axis extending in an axial direction of the roller. The warp inlay yarns may be positioned in the axial direction. In addition, in further embodiments, it may also be conceivable for the warp inlay yarns to be oriented, with respect to the axial direction of the roller, at a warp inlay yarn angle and then would not serve as a reference axes for the braiding angle of the braiding yarns.

In a further embodiment, the wall of the roller may comprise a plurality of layers of the fibre braid, so that the layers are positioned one above another in radial direction. A multilayered construction may also be provided for optimum strength properties.

Furthermore, the layers of the fibre braid may be positioned one above another in an offset manner. In this way, the warp inlay yarns, which may be thicker than the braiding yarns, of the layers positioned one above another may be arranged next to one another. This arrangement may lead to a much more cylindrical shape of the wall and thus of the roller.

In another embodiment of the roller according to the invention, the fibre braid may be constructed of carbon fibres and/or glass fibres. A combination of various types of filaments, in particular of warp inlay yarns made of carbon fibres and braiding yarns made of glass fibres, may be utilized for optimizing the strength properties of the roller. Furthermore, the fibres of various embodiments may include aramid, natural and other braidable fibres.

During the braiding of the fibre braid by using a braiding machine, a braided core may be provided as the basic form for the roller such that the braided core may be braided-round by the fibre braid. The braided core may be distinguished by a braiding-friendly geometry. Such distinction may be met by an at least approximately circular cylindrical configuration of the braided core. A braiding-friendly geometry may be provided when the fibre braid may be positioned tight against the circumferential surface of the braided core. Depending on the roller to be designed, the shape of the roller may also be provided so as to approximate particularly closely the resulting shape of the roller, i.e. so as to be exactly circular cylindrical.

In contradistinction thereto, the braided core may be designed in another embodiment with a radially set-back cross section which may be rectilinear on one side, in particular with rounded-off edges in the axial direction of the roller. Such carried-out flattening in the radially set-back portion of the cross section of the roller may still be implemented within the scope of a braiding-friendly geometry and may allow further components to be attached to the wall that may be attached owing to the function of the roller to be designed.

In another embodiment, the fibre braid of the wall may be braided all the way round the braided core without a seam interrupting the fibre braid as a separating point. Generally, it may be also possible to provide, instead of a fibre braid braided seamlessly around a braided core, a fibre braid mat. The fibre braid mat may be for example placed around a core, in particular in an overlapping manner, and subsequently infiltrated.

It may also be conceivable for an initially seamless fibre braid, which may be originally braided all the way round, to be severed open owing to subsequent working steps, for example, unilaterally in an axial direction. In such a case, the fibre braid may be interrupted at this point. It may be generally beneficial to avoid separating points of this type in order to achieve optimum strength properties of the roller. This may be provided in another embodiment.

In a further embodiment of the roller, the braided core, which may be arranged inside the roller, may be made of a plastics material foam.

A braided core made of plastics material foam may allow for sufficiently precise tolerances and may be sufficiently stable in relation to radial forces of the fibre braid. An alternate embodiment may provide for the braided core to be a hollow plastics material moulding made of a polyester, in particular of polyethylene terephthalate (PET). Such a braided core of this type, which may be similar to a conventional commercial PET plastics material bottle for fresh beverages, also may offer sufficient stability against radial pressure of the fibre braid.

In a further embodiment, the roller may include attachments which are embedded in the plastics material of the roller. This refers to a design of a roller in which a fibre braid, which may be for example closed all the way round, may be infiltrated, together with an attachment, by the plastics material or embedded into a plastics material. In this case, it may be irrelevant what material the attachments are made of. In addition, it may be not specified whether attachments of this type are arranged inside the fibre braid or outside the fibre braid on the wall.

Attachments infiltrated together with the fibre braid may be, firstly, connected particularly securely to the wall or even become part of the wall. Secondly, a method of this type may be particularly economical.

In an embodiment, attachments of the roller may be connected to the wall by the plastics material. Such embodiments may be implemented in that the plastics material in which the fibres are embedded has adhesive properties. Thus, one or more attachments may be adhesively bonded externally or internally to the wall, before, during or after the fibre braid has been infiltrated by the plastics material. Production may not be, depending on requirements, necessarily carried out in one method step.

In another embodiment, the roller has at least one attachment which may be a plastics material moulding, in particular made of polyurethane. Plastics material mouldings of this type may be produced for example in a reaction injection moulding method (RIM method). Attachments made of a mixture of resin and curing agent, in particular a Biresin® mix (®=registered German word mark number DE 731606 from Sika GmbH), having a Shore hardness, which may be achieved in accordance with ISO 868, of D81, may be suitable.

In a configuration of the roller according to another embodiment, the plastics material in which fibres are embedded may be made of epoxy resin. Generally, it has been possible to process various matrix systems. An epoxy resin system advantageously may meet requirements placed on strength parameters in combination with the fibre braid and also may ensure trouble-free infiltrating of the fibre braid with plastics material. From a financial perspective, the epoxy resin system cross links relatively rapidly and in a dimensionally stable manner. It may be also for the system to cure at room temperature.

Conceivable cases of application for rollers of this type for printing machines may include application rollers, plate cylinders, rubber blanket cylinders, impression cylinders, ductor rollers, rubber rollers, air cylinders or air shafts.

In another embodiment, in which the roller may be embodied as a plate cylinder, the plate cylinder may have an attachment which extends over almost or exactly the entire axial length of the plate cylinder and may have a channel which may be provided for receiving a printing plate.

In a plate cylinder of this type, a fastening device may thus already be integrated to receive printing plates. A broad range of embodiments may be conceivable in this regard. Starting from a rectilinear geometry of the cross section of the otherwise circular cylindrical fibre braid, a RIM attachment with a flat underside may for example be arranged on the rectilinear portion lengthwise in the axial direction. In this arrangement, it may be possible to implement a circular cylindrical outer circumference of the plate cylinder by the attachment. The plate channel may be already provided in the RIM attachment. The fibre braid and the RIM attachment may be jointly infiltrated. The plate channel may be kept free by an insert during the infiltrating. Alternately, a method for manufacturing a plate cylinder of this type may also provide for the plate channel to be subsequently milled into the RIM attachment. The use of inserts may then be dispensed with.

A plate channel may cause rotating of the plate cylinder with an imbalance. This imbalance may be compensated for using counterweights.

In using plate cylinders, attachments for supporting the fibre braid on the inside of the fibre braid may be provided. For example, rotationally symmetrical configurations may be conceivable that avoid imbalances caused by the plate channel. Attachments of this type may also have different weights and be arranged, depending on the imbalance, on the inside.

Generally, it may also be conceivable to sever the fibre braid, owing to the plate channel, partially or all the way through. The arrangement of internal attachments might compensate for resulting separating points in the fibre braid and thus compensate otherwise inevitable losses of strength. Such compensation may for example be formed by a planar connection between the radially internal attachment and the radially external fibre braid or the plastics material surrounding the fibre braid, in regions of intersection in the circumferential direction.

A printing machine may be provided in combination with at least one roller. A use of this type of at least one roller in a printing machine allows inter alia a reduction in the workload of machine staff who have to carry out a roller change. For manufacturing the roller, use may be preferably made of a method including at least the following method steps: (a) providing a braided core, (b) braiding-round the braided core with braiding yarns or with braiding and warp inlay yarns of the fibre braid and (c) infiltrating the fibre braid with plastics material.

Many different types of braided cores may be provided for the braid core). In addition, the braided core may be provided as a lost core which does not remain in the cured roller and may be made for example of sand. Lost cores must be manufactured anew for each roller to be produced and are non-reusable. On the other hand, a multiply usable braided core may be provided. Braided cores made of metal may in particular be used for this purpose. Such recycling of braided cores might also have environmental benefits. Other materials may be used for the core in place of the braided cord, such as materials having similar properties to gypsum, for example, but not limited to, Aqua Core made by Advanced Ceramics Research, Inc of 3292 E. Hemisphere Loop, Tucson, Ariz. 85706 (http://www.acrtucson.com).

There may be different possible configurations of the fibre braid according to braiding-round the braided core with braiding yarns or with braiding and warp inlay yarns of the fibre braid step. The manner in which the multilayered braiding-round proceeds may be particularly relevant in this regard. The braided core may be multiply braided-round without severing the braiding yarns and warp inlay yarns between the layers, at least not during the braiding process. For each layer, braiding may be conventionally carried out over the length of the roller. Offset steps of the braiding machine may be provided in the region of the resulting overhang. The offset steps may cause a subsequent layer of the fibre braid to be deposited, with respect to the previously braided fibre braid, in an offset manner on the previously braided layer of the fibre braid. A multilayered construction of the wall may be provided due to mechanical considerations.

The infiltrating of the fibre braid with plastics material according to the step infiltrating the fibre braid with plastics material may include, as described hereinbefore, a common infiltrating of the fibre braid with correspondingly positioned attachments. The infiltrating of the fibre braid may be therefore made possible in a separate method step, after the fibre braid has previously been braided in dry form around the braided core. The dry braiding-round of the braided core may allow an impressive capability of the fibre braid to adapt to braiding-friendly contours of the braided core. In addition, advantages in terms of procedural economy may be attained if the infiltrating of the fibre braid with plastics material and an attachment or a plurality of attachments is carried out jointly. No further method steps may be necessary for adhesively bonding or otherwise fastening the attachments to the infiltrated fibre braid.

An embodiment may provide for the infiltrating of the fibre braid with a plastics material matrix to be carried out with the aid of a vacuum infusion method. The plastics material matrix, also referred to as a matrix for short, may be generally introduced into the fibre braid with the aid of excess pressure or reduced pressure.

In another embodiment a ring gate may be provided. Provision may be made for the infiltrating of the fibre braid to be broken down in detail into the further steps including infusion of the plastics material by a ring gate at an end of the roller, so that from there the infiltrated plastics material may be sucked in the direction of the other end when vacuum may be applied. Further steps also include advancing of a plastics material front of the infiltrated plastics material through the braid and if appropriate past attachments in the axial direction toward the other end of the roller and concluding of the infiltrating at the moment when the plastics material front reaches the other end of the roller or after the plastics material front has reached the other end of the roller.

The plastics material layer may be constructed in a seamless manner, viewed in the circumferential direction, because merging of infiltrated plastics material may not be provided in the circumferential direction of the roller.

Alternately, a linear gate may also be conceivable over the axial length of the roller. Use of the linear gate may have improved rapidity with which the infiltrating could be concluded. Nevertheless, in the case of the linear gate, two plastics material fronts collide in the circumferential direction.

In another embodiment, a further method step may be provided, after providing a dry braiding-round has been carried out. Accordingly, at least one attachment may be positioned with respect to the fibre braid and subsequently, common infiltrating of the fibre braid with the at least one attachment consequently takes place. In this case, it may be that an attachment of this type, which may be immediately jointly cast, may be fixed particularly securely to the fibre braid and can be fastened without increasing the complexity of the method. In addition, it may be possible in attachments of this type to provide geometries or to provide functions which could not be implemented using the component made of fibre braid per se.

According to another embodiment, after the braiding-round, at least one insert may be positioned with respect to the fibre braid. Inserts of this type may be intended as place retainers and are meant to prevent plastics material from being able to flow into the spaces which are filled out by the inserts while the surrounding space may be nevertheless filled at least partially by plastics material. The infiltrating may be possible without remaining trapped air, even if the infiltrating of the fibre braid may be provided together with attachments or inserts.

Inserts are positioned with respect to the fibre braid, although it may be entirely possible in this regard for them also to be positioned in an attachment. In particular, it may be possible in this way to keep a plate channel free in an RIM attachment which may be infiltrated together with the fibre braid. After the common infiltration, the plastics material cures. Subsequently or toward the end of the curing, the insert may be removed, so that the points which are kept free, which the insert previously took up, are now available as a free space for further measures. In this manner, it may be also possible to keep a plurality of free spaces free.

### BRIEF DESCRIPTION OF THE DRAWINGS

The subject matter of the application will be more readily understood from the following detailed description when read in conjunction with the accompanying drawings, in which:

FIG. 1a is a perspective view of a tool for making an attachment for use in an embodiment of the invention;

FIG. 1b is a cross section of an attachment made by the tool shown in FIG. 1a;

FIG. 1c is a radial section of a fibre braid forming a wall of a roller cylinder according to an embodiment of the invention;

FIG. 2 shows the embodiment according to FIGS. 1b and 1c with the attachment being arranged on the fibre braid on a rectilinear side of the cross section of the fibre braid;

FIG. 3 shows a first embodiment according to FIGS. 1b and 1c with the plastics material infiltrated between the attachment and the fibre braid and a channel which may be subsequently milled into the attachment being shown;

FIG. 4 is a radial section of a second embodiment of a plate cylinder with an external attachment with a channel;

FIG. 5 is a radial section of a third embodiment of a plate cylinder with an internal attachment with a channel;

FIG. 6 is a radial section of a fourth embodiment of a plate cylinder with a printing plate; and

FIG. 7 shows a side view of a fibre braid applied to a braided core.

### DETAILED DESCRIPTION

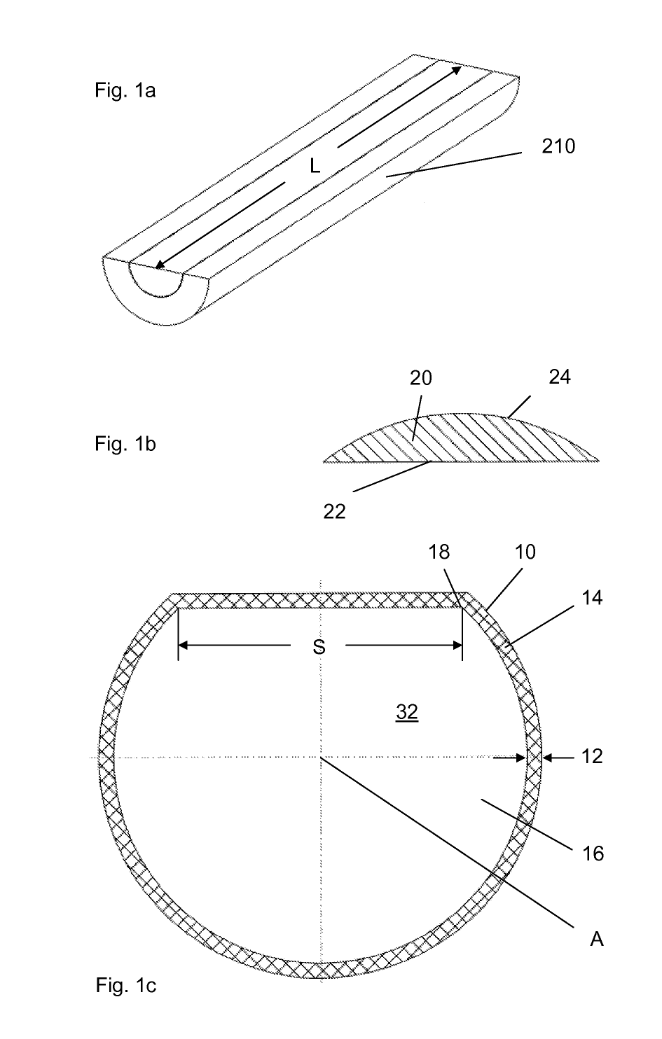

FIGS. 1b, 2, and 3 show a first embodiment of a roller according to the invention which may be embodied as a plate cylinder. The plate cylinder comprises, viewed in radial direction from the inside to the outside, a braided core 16, a wall 10 which may be closed there around and an attachment 20. The wall 10 comprises a fibre braid 14 and plastics material which has infiltrated into the fibre braid 14. The plastics material also wets the surface of the fibre braid 14 at the outer circumference of the plate cylinder in a cylindrical region in which the fibre braid 14 or the wetting layer made of plastics material forms the outer circumference of the plate cylinder. On a rectilinear side of the cross section of the fibre braid 14, the wetting layer made of plastics material may be at the same time an adhesive layer 50 for fixing the attachment 20. In this region of the circumference radially outside the rectilinear side, the attachment 20 consequently forms the outer circumference of the plate cylinder and may be to be understood as part of the plate cylinder.

The braided core 16 may be made of a plastics material foam. It may be a completely filled cylinder having an axial length L (not shown) along a cylinder axis A. In a rectilinear portion S of the cross section of the circumference, which may be otherwise circular cylindrical over the entire length L, the braided core 16 may be radially set back. The portion S may be thus positioned, viewed in the cross section 32 of the braided core 16, perpendicularly to the cylinder axis A, but extends as a surface parallel to the cylinder axis A over the length L of the plate cylinder.

The wall 10 may comprise a fibre braid 14 which may be braided around the braided core 16 over the entire length L. The fibre braid 14 may be constructed from a plurality of layers and rests against the braided core 16 with a tension in radial direction. The wall 10 has an almost constant wall thickness 12 over the entire circumference of the plate cylinder. Thus, the cross section of the wall 10 may be also rectilinear in accordance with the shape of the braided core 16 in the region of the portion S.

The more layers of the fibre braid 14 are positioned one above another, the greater the wall thickness 12 is. The layers may be arranged one above another in an at least slightly offset manner in order to attain a cylindrical shape of the roller 1. The layers may be produced by repeated braiding-over of the braided core 16 in the axial direction. Braiding may be in this case carried out initially over the length L.

After the repeated braiding-over, the fibre braid 14 may be fixed at the ends of the future plate cylinder on the braided core 16, for example by adhesive tape. The fibre braid 14 may be up until this point still dry, i.e. not infiltrated with plastics material (FIG. 1c). The protruding ends may be severed off, so that the fibre braid 14 may be cropped at the ends. This type of severing of the edges of the layers of the fibre braid 14 may of course also be carried out while using much less material. For example, severing may also be carried out only after the infiltration.

In accordance with the conventional function of a plate cylinder, provision may be made to fasten a printing plate on this roller. For this purpose, a channel 30 for receiving the ends of the printing plate may be provided in the axial direction. The channel 30 has a depth R in radial direction, may be configured in accordance with the requirements of known plate fastening mechanisms and may differ significantly from the illustrated form. A broad range of channel geometries may be provided in the attachment 20 before the infiltrating. Alternately, the channel geometries may be introduced into the attachment 20 according to FIG. 1b using machining operations only afterwards. This may be also how it happened in the first embodiment.

FIGS. 1b and 1c are a radial section through the first embodiment of a plate cylinder according to the invention. FIG. 1a shows a tool 210 for producing the attachment 20 by a RIM method. The attachment 20 according to FIG. 1b, which may be generated in a method of this type, extends over the entire axial length L of the plate cylinder. Accordingly, the tool 210 may be also designed so as at least to have a length L. Facing the plate cylinder, the attachment 20 has a flat surface 22, whereas a rounding 24 may be provided remote from the plate cylinder. The rounding 24 has exactly or almost exactly the same curvature as the plate cylinder.

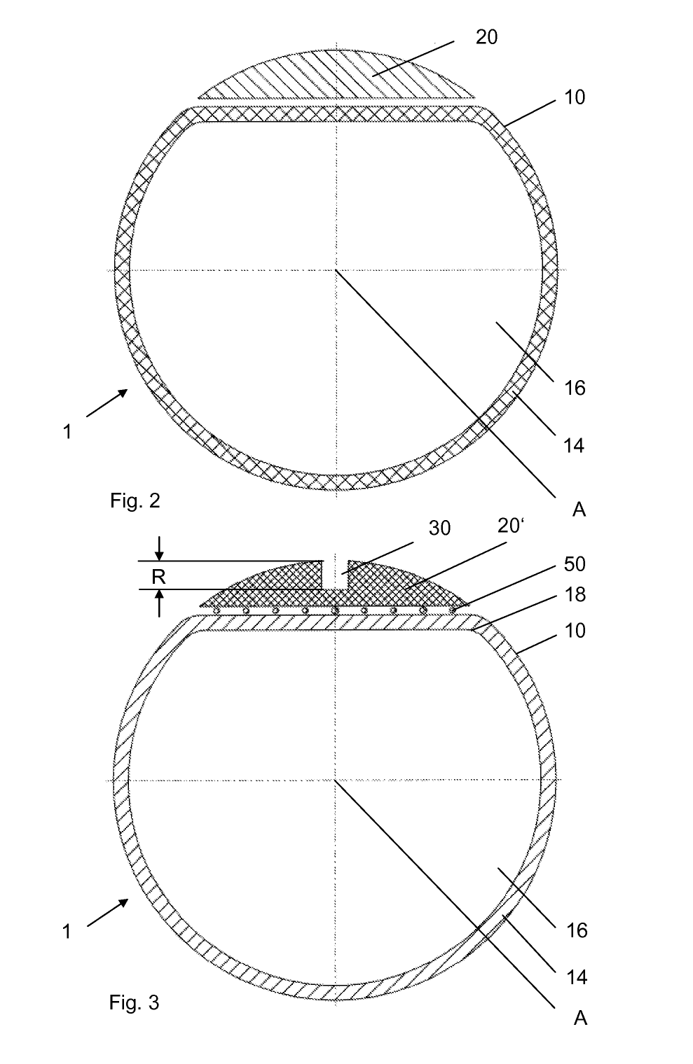

FIG. 2 shows the attachment 20 and fibre braid 14 in the final positioning relative to each other, so that the resulting plate cylinder has a circular cylindrical outer circumference.

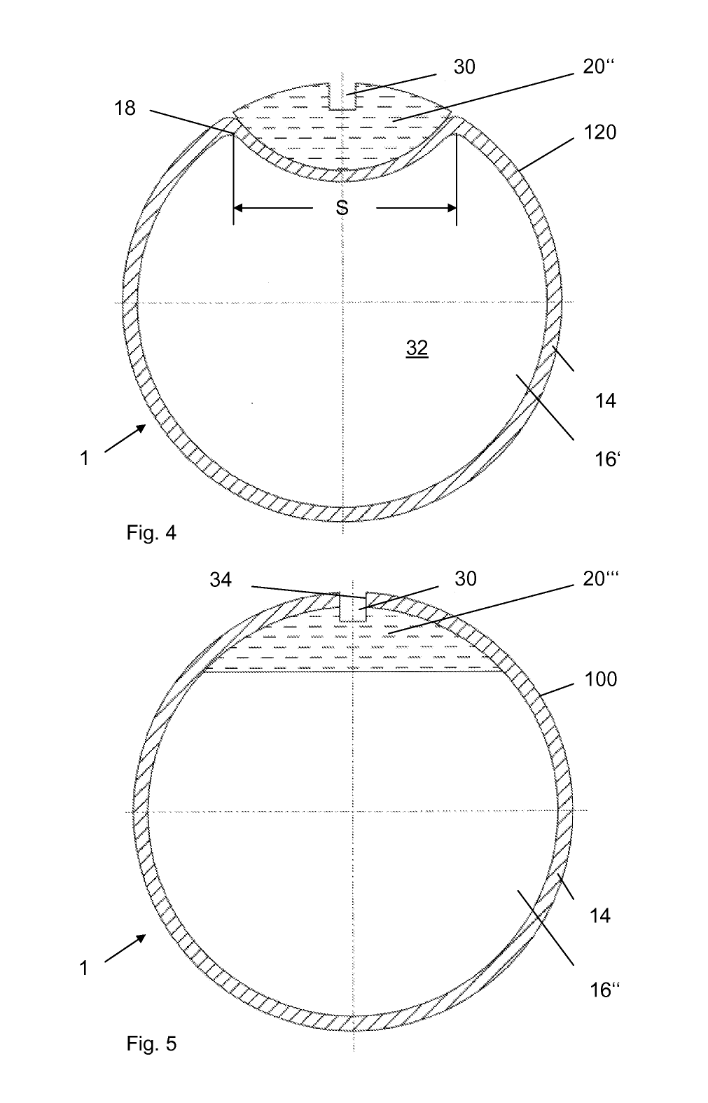

FIG. 3 shows, indicated by small circles, the adhesive layer 50 between an attachment 20′ and the fibre braid 14. As described herein before, the adhesive layer 50 may be produced during common infiltrating with plastics material. Alternately, the attachment 20′ can also be fixed retrospectively to the previously infiltrated and already cured wall 10 in the region of the portion S of the braided core 16.

FIG. 3 shows a channel 30 in the attachment 20′. The channel 30 has been milled into the attachment 20′, after the attachment 20′ and the fibre braid 14 have been jointly infiltrated and the infiltrated plastics material has cured. A channel of this type may already have been provided in an alternate attachment which may be similar to the attachment 20′. An alternate attachment of this type would be filled, for example during the infiltrating, with an insert (not shown), thus preventing any plastics material from penetrating the space filled with the insert.

Axis-parallel edges 18 of the portion S of the braided core 16 may be designed in an especially braiding-friendly manner when they outwardly enter into contact with the fibre braid 14 not in a sharp, but rather in a rounded-off manner.

FIG. 4 shows a second embodiment of a plate cylinder. In this case, a wall 120 may be designed in a non-braiding-friendly manner. In the wall 120, a fibre braid 14 may also be designed as in the first embodiment, the fibre braid being braided around a braided core 16′. The geometry at the braided core 16′ may be not braiding-friendly, because the braided core may have in its cross section 32 a concave portion S extending along its longitudinal axis. During the braiding-round of the braided core 16′, the dry fibre braid 14 does not readily assume the concave shape of the portion S. Otherwise it would require the provision during the braiding of measures according to a method disclosed in DE 10 2004 037 121 A1, which measures hold the fibre braid in the portion S resting against the surface of the braided core 16′.

In the region of the portion S, an attachment 20″ may be positioned on the wall 120, in which the channel 30 may be designed in the axial direction. The second embodiment might have advantages during the positioning of the channel on the wall 120, because the position may be almost inevitably assumed in the portion S. Also, during operation of the plate cylinder, tangential forces may act on the channel 30 and on the attachment 20″. These tangential forces may be accommodated, in such a configuration of the receptacle of the attachment 20″, by the plate cylinder also via a form-fitting connection to the wall 120.

In an alternate method for manufacturing a plate cylinder, the wall may first be infiltrated and subsequently cure. Subsequently, a pre-produced attachment may be fixed thereto, for example by adhesive bonding.

FIG. 5 illustrates a third embodiment of a plate cylinder according to the invention with a braided core 16″ which may be at least similar to the braided core 16 of the first embodiment. An attachment 20′″ may be attached inside the plate cylinder to the braided core 16″ at the point at which the rectilinear portion S of the braided core 16 was positioned in the first embodiment.

In the third embodiment, on the other hand, the attachment 20′″ may be positioned within a now continuously circular cylindrical wall 100. As in the other embodiments, the wall 100 has a fibre braid 14. The wall 100 may be radially perforated for configuring the channel 30 in the axial direction, thus forming a separating point 34. The channel 30 may be embodied so as to pass through the separating point 34 into the attachment 20′″. The separating point 34 initially has an adverse effect on the strength properties of the plate cylinder compared to the other embodiments. In order to compensate for this, on the one hand, the attachment 20′″ bridges the separating point 34. On the other hand, the transition between the two ends of the wall 100 may be configured so as to reach over in the channel 30, thus ensuring a connection between these two ends.

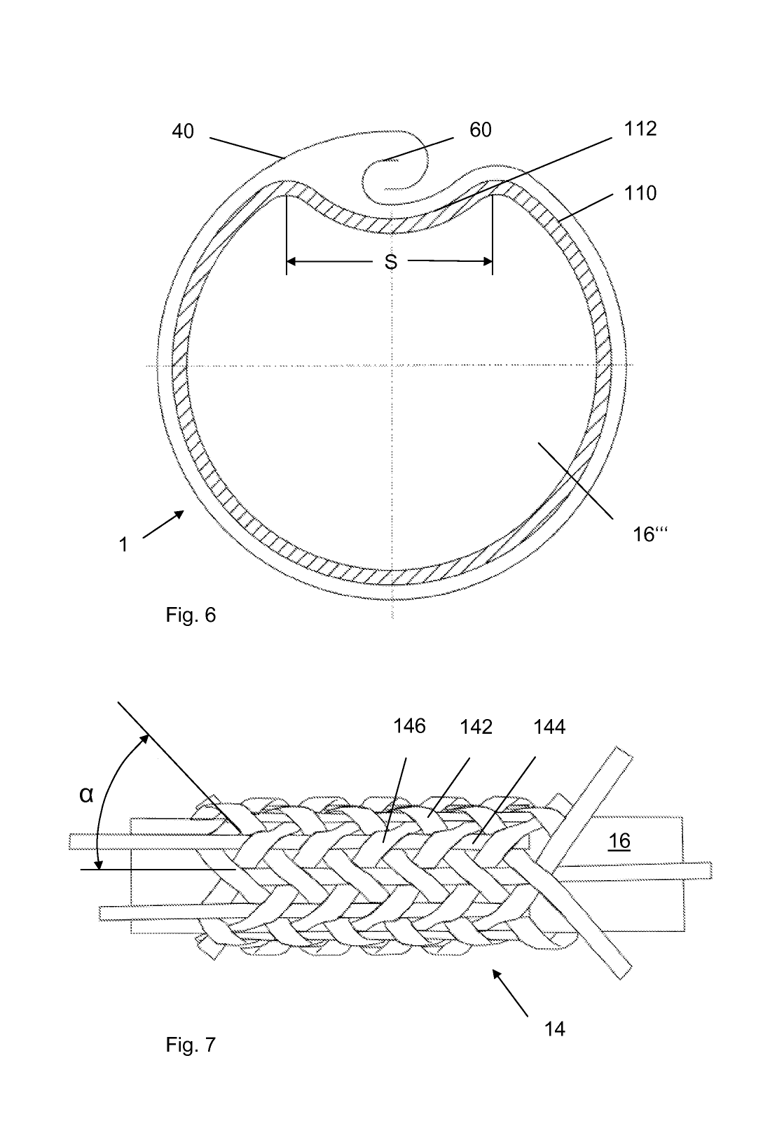

FIG. 6 shows a fourth embodiment of a plate cylinder according to the invention without an attachment. The fourth embodiment may be similar to the second embodiment with respect to the configuration of a wall 110. The wall 110 may be designed with a restricted circular cylindrical cross section over the length L of the plate cylinder. The restriction comprises in a concavely designed region 112 radially outside the portion S a braided core 16′″ which may be similar to the braided core 16′ from the second embodiment.

In this variant according to the fourth embodiment, a packing, which may be embodied as a printing plate 40, may be placed in an almost circular cylindrical manner around the plate cylinder and be closed radially outside the region 112 with a closure 60. The closure 60 may be formed by curved ends of the printing plate 40 in such a way that the ends mesh with one another.

Generally, alternate possibilities for fastening a packing may be considered owing to the novel plate cylinder. These include printing plates which may be inserted into grooves encircling in the circumferential direction. The grooves (not shown) for receiving the printing plate are provided at the outer circumference of the ends of the plate cylinder. Alternately, vacuum fixings of the printing plate are possible. The vacuum fixing may be assisted by at least one axial groove in the plate cylinder. Adhesive bonding of the printing plate on the plate cylinder may also be considered.

FIG. 7 shows a triaxial fibre braid 14 applied to a braided core 16 in a schematic view intended to illustrate the geometry of the fibre braid 14. In the axial direction, warp inlay yarns 144 of a layer of the fibre braid 14 are braided-in (weaved) between braiding yarns 142, 146. A circular braiding technique is disclosed, for example, in published U.S. Patent Application No. 2007/0193439, the teachings of which may be employed for manufacturing a braided plate cylinder according to the invention.

Instead of triaxial braids, biaxial or unidirectional embodiments of the fibre braid are also conceivable. In the case of unidirectional embodiments, yarns or strips which are oriented in one direction do not cross over within a layer. Nevertheless, unidirectional embodiments are to be regarded as being in accordance with the invention.

The braiding yarns 142, 146 and warp inlay yarns 144 are braided in the triaxial braid at braiding angles α of from 45° to 90° and in particular from 60° to 70° relative to one another. They comprise carbon and/or glass fibres. Accordingly, a hybridization of the fibre braid may be provided. The warp inlay yarns 144 may be made from carbon fibres and the braiding yarns 142, 146 from glass fibres. Polyethylene fibres or natural fibres might also be used. About 1,000 (1 k) to 50,000 (50 k) individual filaments may be combined in the yarns. Preferably, 12 k braiding yarns and 50 k warp inlay yarns have been used in a prototype. Intermediate compacting steps may be necessary when the fibre braid 14 may be constructed from a plurality of layers.

Generally, mounting of a braided tube onto a braided core may also be conceivable, although this may have drawbacks compared to above-described braided-on fibre braids 14 with respect to procedural safety and mechanical properties. The braiding-round may allow for better adaptation to the braided core and the braiding yarns may not be subjected to unnecessary stress as a result of mounting.

It will be understood that the above description of the present invention may be susceptible to various modifications, changes and adaptations, and the same are intended to be comprehended within the meaning and range of equivalents of the appended claims.

What is claimed is:

1. A roller for a printing machine, comprising:
a cylindrically shaped wall comprising at least partially one layer of a fiber braid and plastics material infiltrated in the fiber braid.

2. The roller according to claim 1, wherein the at least one layer of the fiber braid comprises a plurality of layers arranged one above another in a radial direction.

3. The roller according to claim 2, wherein the plurality of layers of the fiber braid are offset from each other in the radial direction.

4. The roller according to claim 1, wherein the fiber braid comprises at least one of triaxially braided yarns or biaxially braided yarns, wherein the triaxially braided yarns include both biaxial braiding yarns and warp inlay braiding yarns and wherein the biaxially braided yarns include biaxial braiding yarns.

5. The roller according to claim 4, wherein the biaxial braiding yarns are arranged at an angle approximately from 45 degrees to 90 degrees relative to one another.

6. The roller according to claim 4, wherein the biaxial braiding yarns are arranged at an angle approximately from 60 degrees to 70 degrees relative to one another.

7. The roller according to claim 4, wherein the warp inlay braiding yarns are arranged in an axial direction of the roller and weaved between the biaxial braiding yarns.

8. The roller according to claim 1, wherein the fibers comprise at least one of a thermoplastic polymer, a natural fiber, or other braidable fibers.

9. The roller according to claim 1, further comprising an at least approximately circular cylindrical braided core, wherein the wall is arranged at least approximately circular cylindrically around the at least approximately circular cylindrical braided core.

10. The roller according to claim 9, wherein the braided core comprises a plastics material foam or a hollow plastics material moulding comprising polyester.

11. The roller according to claim 9, wherein the braided core includes a substantially circular cylindrical cross-section along the axis of the roller, wherein the cross-section includes a radially set-back portion.

12. The roller according to claim 11, wherein the set-back portion extends rectilinearly or concavely.

13. The roller according to claim 11, wherein the braided core includes rounded-off edges in the axial direction of the roller to delimit the set-back portion.

14. The roller according to claim 1, wherein the fiber braid is seamlessly braided-round.

15. The roller according to claim 1, further comprising at least one attachment, wherein the attachment is at least one of embedded in the plastics material or coupled to the wall.

16. The roller according to claim 1, further comprising at least one attachment, wherein the attachment comprises a plastics material moulding.

17. The roller according to claim 1, wherein the plastics material comprises an epoxy resin.

18. The roller according to claim 1, wherein the roller is a plate cylinder.

19. The roller according to claim 18, further comprising at least one attachment extending over approximately an axial length of the roller, wherein the attachment defines a channel into which a printing plate is insertable.

20. The roller according to claim 1, wherein the roller comprises one of a rubber blanket cylinder, an application roller, an impression cylinder, a doctor roller, a rubber roller, an air cylinder, or an air shaft.

21. A combination comprising a printing machine and the roller according to claim 1.

22. A method of manufacturing a roller, comprising:
providing a braided core;
surrounding the braided core with at least one of braiding yarns or braiding yarns and warp inlay yarns to form a fiber braid; and
infiltrating the fiber braid with plastics material.

23. The method according to claim 22, further comprising using the braided core as a lost core or a multiple usable core.

24. The method according to claim 23, wherein the multiple usable core comprises metal.

25. The method according to claim 22, wherein the surrounding comprises repeating the formation of the fiber braid a plurality of times over the axial length of the roller to produce a plurality of layers of the fiber braid.

26. The method according to claim 22, wherein the infiltrating step includes using a vacuum infusion method.

27. The method according to claim 22, wherein the infiltrating step includes
initiating the infiltrating with a ring gate at an end of the roller,
advancing a front of the plastics material in an axial direction of the roller, and
concluding the infiltrating when or after the front reaches the other end of the roller.

28. The method according to claim 22, wherein following the surrounding step, positioning at least one attachment with respect to the fiber braid, wherein the infiltrating step includes commonly infiltrating the at least one attachment with the fiber braid is infiltrated with the plastics material.

29. The method according to claim 28, wherein following the surrounding step, positioning at least one insert with the fiber braid on the roller to prevent the plastics material from infiltrating the roller at an area covered by the insert, and following the infiltrating step, curing the plastics material and removing the insert from the roller to define a space not infiltrated by the plastics material.
